(19) United States
(12) Patent Application Publication
(10) Pub. No.: US 2025/0106791 A1
(43) Pub. Date: Mar. 27, 2025

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jianfei CAO, Dongguan (CN)

(73) Assignee: GUANGDONG OPPO MOBILE TELECOMMUNICATIONS CORP., LTD., Dongguan (CN)

(21) Appl. No.: 18/974,194

(22) Filed: Dec. 9, 2024

Related U.S. Application Data
(63) Continuation of application No. PCT/CN2022/098251, filed on Jun. 10, 2022.

(51) Int. Cl. H04W 56/00; H04W 74/0833

(52) U.S. Cl. CPC H04W 56/001; H04W 74/0833

(57) ABSTRACT

A communication method, a terminal device, and a network device are provided. The method includes: in a case that a timing advance TA of a first transmitting and receiving point TRP is invalid, performing, by a terminal device, one or more of the following operations: communicating with a second TRP based on a TA of the second TRP; or restoring the TA of the first TRP to be valid, where the TA of the second TRP is valid, and the first TRP and the second TRP belong to one serving cell of the terminal device.

### CROSS-REFERENCE TO RELATED APPLICATION

This application is a continuation of International Application No. PCT/CN2022/098251, filed on Jun. 10, 2022, the disclosure of which is hereby incorporated by reference in its entirety.

### TECHNICAL FIELD

This application relates to the field of communications technologies, and more specifically, to a communication method, a terminal device, and a network device.

### BACKGROUND

In a conventional manner, a timing advance (timing advance, TA) is configured by using a serving cell as a granularity. After a TA of the serving cell fails, a terminal device cannot communicate with a transmitting and receiving point (transmitting and receiving point, TRP) in the serving cell.

### SUMMARY

This application provides a wireless communication method, a terminal device, and a network device. Various aspects of this application are described below.

According to a first aspect, a terminal device is provided, including: a processor and a memory, wherein the memory is configured to store a computer program, and the processor is configured to execute the computer program stored in the memory to cause the terminal device to perform a method of: in a case that a timing advance (TA) of a first transmitting and receiving point (TRP) is invalid, performing one or more of following operations: communicating with a second TRP based on a TA of the second TRP; or restoring the TA of the first TRP to be valid, wherein the TA of the second TRP is valid, and the first TRP and the second TRP belong to one serving cell of the terminal device.

According to a second aspect, a network device is provided, including: a processor and a memory, wherein the memory is configured to store a computer program, and the processor is configured to execute the computer program stored in the memory to cause the network device to perform a method of: in a case that a timing advance (TA) of a first transmitting and receiving point (TRP) is invalid, performing one or more of following operations: communicating with a second TRP based on a TA of the second TRP; or restoring the TA of the first TRP to be valid, wherein the TA of the second TRP is valid, and the first TRP and the second TRP belong to one serving cell of the terminal device.

According to a third aspect, a communication method is provided, including: in a case that a timing advance TA of a first transmitting and receiving point TRP is invalid, performing, by a terminal device, one or more of the following operations: communicating with a second TRP based on a TA of the second TRP; or restoring the TA of the first TRP to be valid, where the TA of the second TRP is valid, and the first TRP and the second TRP belong to one serving cell of the terminal device.

### BRIEF DESCRIPTION OF DRAWINGS

FIG. 1A to FIG. 1C are system architectural diagrams of communications systems to which embodiments of this application are applicable.

FIG. 2 shows a format of a MAC CE that carries a TAC.

FIG. 3 shows a format of a MAC CE that carries a TAC.

FIG. 4 shows a format of a MAC RAR that carries a TAC.

FIG. 5 is a schematic diagram of a multi-TRP scenario to which an embodiment of this application is applicable.

FIG. 6 is a flowchart of a communication method according to an embodiment of this application.

FIG. 7 is a schematic diagram of a terminal device according to an embodiment of this application.

FIG. 8 is a schematic diagram of a network device according to an embodiment of this application.

FIG. 9 is a schematic structural diagram of an apparatus according to an embodiment of this application.

### DESCRIPTION OF EMBODIMENTS

### Communications System Architecture

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, an NTN system, a universal mobile telecommunications system (UMTS), a wireless local area network (WLAN), wireless fidelity (WiFi), a fifth-generation (5G) system, or another communications system, for example, a future communications system such as a sixth-generation mobile communications system or a satellite communications system.

Generally, a number of connections supported by a conventional communications system is limited, and is also easy to implement. However, with development of communications technologies, a mobile communications system not only supports conventional communication, but also supports, for example, device-to-device (D2D) communication, machine-to-machine (M2M) communication, machine type communication (MTC), vehicle-to-vehicle (V2V) communication, or vehicle to everything (V2X) communication. Embodiments of this application may also be applied to these communications systems.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial network (TN) system. By way of example rather than limitation, the NTN system includes an NR-based NTN system and an IoT-based NTN system.

Embodiments of this application are described with reference to a network device and a terminal device. The terminal device may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus or the like.

In embodiments of this application, the terminal device may be a station (ST) in a WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN).

In embodiments of this application, the terminal device may be a device providing a user with voice and/or data connectivity and capable of connecting people, objects, and machines, such as a handheld device or a vehicle-mounted device having a wireless connection function. The terminal device in embodiments of this application may be a mobile phone, a pad, a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety (transportation safety), a wireless terminal in smart city, a wireless terminal in smart home, or the like. Optionally, the terminal device may function as a base station. For example, the terminal device may function as a scheduling entity that provides a sidelink signal between terminal devices in V2X, D2D, or the like. For example, a cellular phone and a vehicle communicate with each other by using a sidelink signal. A cellular phone and a smart household device communicate with each other without relaying a communication signal by a base station.

In embodiments of this application, the terminal device may be deployed on land, including being indoors or outdoors, may be handheld, wearable, or vehicle-mounted; may be deployed on water (for example, on a ship); or may be deployed in the air (for example, on an airplane, a balloon, or a satellite).

In embodiments of this application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like. The terminal device in embodiments of this application may also be referred to as a terminal, user equipment (UE), an access terminal device, a vehicle-mounted terminal, an industrial control terminal, a UE unit, a UE station, a mobile site, a mobile station, a remote station, a remote terminal device, a mobile device, a UE terminal device, a wireless communications device, a UE agent, a UE apparatus, or the like. The terminal device may be stationary or mobile.

By way of example rather than limitation, in embodiments of this application, the terminal device may alternatively be a wearable device. The wearable device may also be referred to as a wearable smart device, and is a general term for wearable devices such as glasses, gloves, watches, clothes, and shoes that are intelligently designed and developed by applying wearable technologies to daily wearing. The wearable device is a portable device that is directly worn on a body or integrated into clothes or an accessory of a user. In addition to being a hardware device, the wearable device can also implement powerful functions through software support, data exchange, and cloud interaction. In a broad sense, the wearable smart device includes a full-featured and large-sized device that can implement all or some functions without relying on a smartphone, for example, a smart watch or smart glasses, and a device that only focuses on a specific type of application function and needs to be used in cooperation with another device such as a smartphone, for example, various smart bracelets and smart jewelries for physical sign monitoring.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be replaced with the following names, such as a NodeB, an evolved NodeB (eNB), a next generation NodeB (gNB), a relay station, a transmitting and receiving point (TRP), a transmitting point (TP), a master eNodeB MeNB, a secondary eNodeB SeNB, a multi-standard radio (MSR) node, a home eNodeB, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. The base station may be alternatively a communications module, a modem, or a chip disposed in the foregoing device or apparatus. Alternatively, the base station may be a mobile switching center, a device that functions as a base station in device-to-device D2D, vehicle-to-everything (V2X), and machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move depending on a location of the mobile base station. In another example, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted; may be deployed on a water surface; or may be deployed on a plane, a balloon, or a satellite in the air. In embodiments of this application, a scenario in which the network device and the terminal device are located is not limited.

By way of example rather than limitation, in embodiments of this application, the network device may have a mobile feature, for example, the network device may be a movable device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell (small cell). The small cell herein may include a metro cell, a micro cell, a pico cell, a femto cell, or the like. These small cells feature small coverage and low transmit power, and are suitable for providing a high-speed data transmission service.

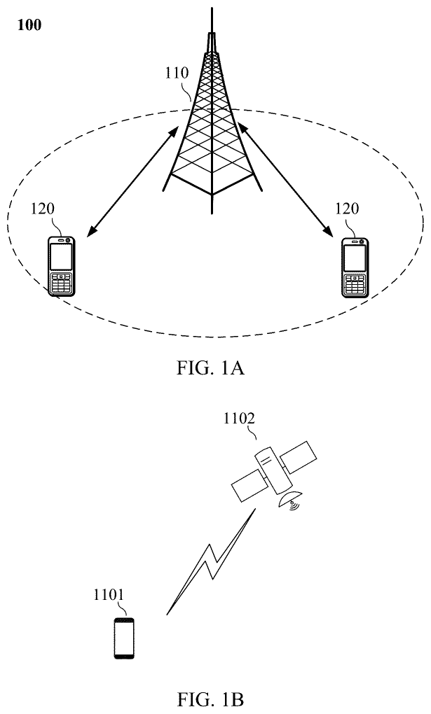

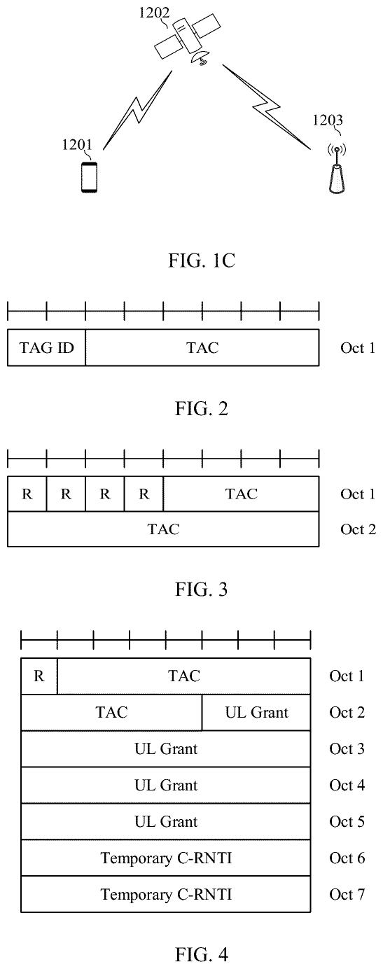

Exemplarily, FIG. 1A is a schematic diagram of an architecture of a communications system according to an embodiment of this application. As shown in FIG. 1A, a communications system 100 may include a network device 110, and the network device 110 may be a device that communicates with a terminal device 120 (or referred to as a communications terminal or a terminal). The network device 110 may provide communication coverage for a specific geographical area, and may communicate with the terminal device within the coverage area.

FIG. 1A exemplarily shows one network device and two terminal devices. In some embodiments of this application, the communications system 100 may include a plurality of network devices, and another number of terminal devices may be included within a coverage range of each network device. This is not limited in embodiments of this application.

Exemplarily, FIG. 1B is a schematic diagram of an architecture of another communications system according to an embodiment of this application. Referring to FIG. 1B, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and direct communication may be performed between the terminal device 1101 and the satellite 1102. In this system architecture, the satellite 1102 may be referred to as a network device. In some embodiments of this application, the communications system may include a plurality of network devices 1102, and another number of terminal devices may be included within a coverage range of each network device 1102. This is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed among the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 needs to be relayed by using the satellite 1202. In this system architecture, the base station 1203 may be referred to as a network device. In some embodiments of this application, the communications system may include a plurality of network devices 1203, and another number of terminal devices may be included within a coverage range of each network device 1203. This is not limited in embodiments of this application.

It should be noted that FIG. 1A to FIG. 1C are merely examples of systems to which this application is applicable. Certainly, the methods shown in embodiments of this application may also be applied to other systems, such as a 5G communications system and an LTE communications system. This is not specifically limited in embodiments of this application.

In some embodiments of this application, the wireless communications systems shown in FIG. 1A to FIG. 1C may further include another network entity such as a mobility management entity (MME) or an access and mobility management function (AMF). This is not limited in embodiments of this application.

It should be understood that a device having a communication function in a network/system in embodiments of this application may be referred to as a communications device. The communications system 100 shown in FIG. 1A is used as an example. The communications device may include the network device 110 and the terminal device 120 that have a communication function. The network device 110 and the terminal device 120 may be the foregoing specific devices, and details are not described herein again. The communications device may further include another device in the communications system 100, for example, another network entity such as a network controller or a mobility management entity. This is not limited in embodiments of this application.

It should be understood that, an “indication” mentioned in embodiments of this application may be a direct indication or an indirect indication, or may indicate an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In descriptions of embodiments of this application, the term “corresponding” may mean that there is a direct or indirect correspondence between the two, or may mean that there is an association relationship between the two, or may mean that there is a relationship such as indicating and being indicated, or configuring and being configured.

“Configured” in embodiments of this application may include being configured by using at least one of a system message, radio resource control (RRC) signaling, or a media access control control element (MAC CE).

In some embodiments of this application, “predefined” or “preset” may be implemented by prestoring corresponding code or a corresponding table in a device (for example, including the terminal device and the network device) or in other manners that can be used to indicate related information, and a specific implementation thereof is not limited in this application. For example, being predefined may refer to being defined in a protocol.

In some embodiments of this application, the “protocol or standard” may refer to a standard protocol in the communications field, and may include, for example, an LTE protocol, an NR protocol, and a related protocol applied to a future communications system, which is not limited in this application.

For ease of understanding, some related technical knowledge related to embodiments of this application is first introduced. The following related technologies, as optional solutions, may be randomly combined with the technical solutions of embodiments of this application, all of which fall within the protection scope of embodiments of this application. Embodiments of this application include at least part of the following content.

### Timing Advance (Timing Advance, TA)

The TA is generally used for uplink transmission, and may mean that a system frame in which a terminal device sends uplink data should be a specific time ahead of a respective downlink frame. For example, a timing advance for the terminal device is performing transmission in advance on a basis of using the first symbol of a slot in which the terminal device receives a downlink channel or a channel as a downlink reference.

A carrier aggregation scenario is used as an example. The terminal device may support different carriers (also referred to as “serving cells”). Different carriers may have different TAs. Therefore, a concept of a timing advance group (TAG) is introduced. Generally, one TAG may include TAs of one or more serving cells. A TAG including a special cell (Spcell) may be referred to as a primary timing advance group (PTAG), and correspondingly, a TAG other than the PTAG may be referred to as a secondary timing advance group (STAG). The Spcell may include a primary cell (PCell) or a primary secondary cell (PSCell).

According to current communications standards (including NR, 3GPP Rel.17, and the like), in a cell group (CG), the terminal device may be configured with a maximum of four timing advance groups (TAG). An RRC configuration for configuring a TAG may be expressed as follows:

```
  -- ASN1START
  -- TAG-TAG-CONFIG-START
```

| | |
|---|---|
| TAG-Config ::= | SEQUENCE { |
| tag-ToReleaseList | SEQUENCE (SIZE (1..maxNrofTAGs)) |
| | OF |

TAG-Id OPTIONAL, -Need N

| | |
|---|---|
| tag-ToAddModList | SEQUENCE (SIZE (1..maxNrofTAGs)) |
| | OF |

```
  TAG OPTIONAL-- Need N
  }
```

| | |
|---|---|
| TAG ::= | SEQUENCE { |
| tag-Id | TAG-Id, |
| timeAlignmentTimer | TimeAlignmentTimer, |

```
    ...
  }
```

| | |
|---|---|
| TAG-Id ::= | INTEGER (0..maxNrofTAGs-1) |
| TimeAlignmentTimer ::= | ENUMERATED {ms500, ms750, |

```
ms1280, ms1920, ms2560, ms5120, ms10240, infinity}
  -- TAG-TAG-CONFIG-STOP
  -- ASN1STOP
```

Generally, the RRC configuration may include a TAG configuration (denoted by “TAG-Config”), TAG information (denoted by “TAG”), a TAG identity (denoted by “TAG-Id”), and a TA timer (denoted by “timeAlignmentTimer”). The TAG configuration may include a release list (denoted by “tag-ToReleaseList”) and a TAG add list (denoted by “tag-ToAddModList”). The TAG information may include a TAG identity (denoted by “tag-Id”) and a TA timer (denoted by “timeAlignmentTimer”). Duration corresponding to the TA timer may be listed in an enumeration manner, including {500 ms, 750 ms, 1280 ms, 1920 ms, 2560 ms, 5120 ms, 10240 ms, infinity}.

Generally, validity of a TA may be maintained by using a TA timer. In other words, when a terminal device receives information indicating a TA and sent by a network device (for example, a TA command (TAC) below), the terminal device may start or restart a TA timer. When the TA timer does not expire, the TA maintained by the TA timer is valid, and the terminal device may communicate with the network device based on the TA. On the contrary, when the TA timer expires, the TA maintained by the TA timer fails (or is invalid), and the terminal device can no longer communicate with the network device based on the TA in this case.

It should be noted that one CG may include a plurality of serving cells, and one TAG identity is allocated to each serving cell.

As described above, the TAG information may include a TAG identity and a TA timer. In other words, the TA timer included in the TAG configuration is used to maintain validity of a TA in a TAG indicated by the TAG identity. In this case, for ease of description, it may be said hereinafter that the TA timer is associated with the TAG.

The following describes how to calculate a TA.

In some implementations, a TA may be calculated by using a formula (N_{TA}+N_{TA,offset})×T_{c}, where N_{TA,offset} denotes a timing advance offset (TA offset), N_{TA} denotes a TA adjustment amount, and T_{c} denotes a minimum time unit in a communications system (for example, an NR system). Typically, T_{c}=1/(4096×480 kHz).

Generally, in one CG, each serving cell may be preconfigured with one N_{TA,offset}. In addition, for N_{TA}, differential adjustment may be provided by a MAC CE of the network device, that is, a current TA (also referred to as a “new TA” and denoted by N_{TA}_{_{new}}) is adjusted forward or backward in terms of time based on a previous TA (also referred to as an “old TA” and denoted by N_{TA}_{_{old}}). A calculation formula for the adjustment is as follows:

$${N}_{( {TA}_{new} )} = {N}_{( {TA}_{old} )} + ( {T}_{A} - 31 ) * 16 * 64 * / {2}^{μ}$$

Alternatively, N_{TA}_{_{old}} is a TA adjustment amount used before a TA command (TAC) is received, and N_{TA}_{_{new}} is a TA adjustment amount updated after the TAC is received. T_{A} is determined based on the TAC. In addition, a granularity for the T_{A} adjustment may be a TAG.

FIG. 2 shows a format of a media access control control element (MAC CE) that carries a TAC. Referring to FIG. 2, the MAC CE may include a TAG identity (TAG ID) field and a TAC field. Generally, a length of the TAG ID field may be two bits, and an identity of a TAG that includes a SpCell is 0. The TAC field is used to indicate a T_{A} index value T_{A} (0, 1, 2, . . . 63) for controlling a timing adjustment amount that a MAC entity has to apply (as specified in TS 38.213 [6]). A length of the field may be six bits.

In some other implementations, the TA adjustment manner may be based on a TA absolute value (also referred to as an “absolute TA”). That is, a previous TA adjustment value does not need to be considered, and the network device may directly give an absolute TA “N_{TA}′” by using a payload of an absolute MAC CE (Absolute MAC CE) or an RAR MAC. Generally, a value of the absolute TA may range from 0 to 3846. Correspondingly, the TA may be calculated by using a formula N_{TA}′=T_{A}×16×64×2^{μ}, where T_{A} is determined based on the TAC.

In some scenarios, the absolute TA and T_{A} described above are obtained in a random access procedure, and the obtained TA is applicable to a TAG corresponding to a target cell for random access. Therefore, signaling that carries a TAC may not include a TAG-ID. For example, the absolute MAC CE may be used in a 2-step random access procedure, and 2-step random access may be initiated to a SpCell. Therefore, the absolute MAC CE is applicable to a PTAG corresponding to the MAC entity, that is, the PTAG includes a SpCell.

FIG. 3 shows a format of a MAC CE that carries a TAC. Referring to FIG. 3, a length of the MAC CE may be two bytes, namely, 16 bits. The MAC CE may include a TAC field, and the TAC field may occupy 12 bits. This field is used to indicate a TA index value of a time adjustment amount that a MAC entity applies. In addition, the remaining four bits in the MAC CE may be used as reserved bits (denoted by “R”) and may be set to 0.

FIG. 4 shows a format of a MAC random access response (RAR) that carries a TAC. Referring to FIG. 4, a length of the MAC RAR may be seven bytes, namely, 56 bits. A first byte (denoted by “Oct 1”) may include a TAC field, and the TAC field may occupy seven bits. This field is used to indicate a TA index value of a time adjustment amount that a MAC entity applies. The remaining one bit in the Oct 1 may be used as a reserved bit (denoted by “R”) and may be set to 0.

A second byte (denoted by “Oct 2”) may also include a TAC field, and the TAC field may occupy five bits. The remaining three bits in the Oct 2 may carry an uplink grant (UL Grant).

In a third byte to a fifth byte (denoted by “Oct 3 to Oct 5”), an uplink grant (UL Grant) may also be carried. In a sixth byte and a seventh byte (denoted by “Oct 6 and Oct 7”), a temporary cell-radio network temporary identifier (C-RNTI) may be carried.

Scheduling in a Multi-TRP (Multi-TRP, mTRP) Scenario

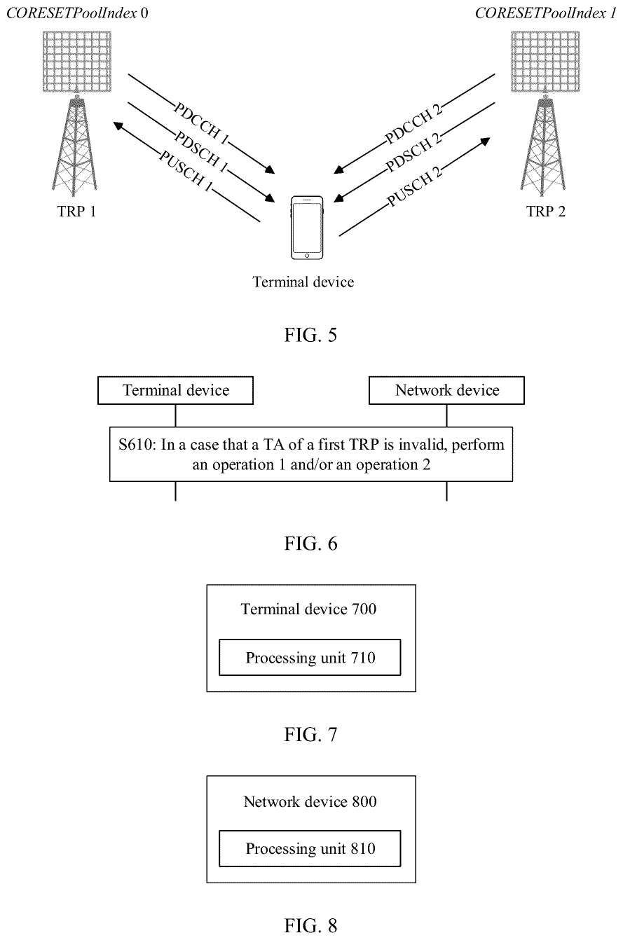

Referring to FIG. 5, in a multiple DCT-multi-TRP (mDCI-mTRP) scenario, each TRP may schedule transmission of its PDSCH by using respective DCI. That is, a TRP 1 may schedule transmission of a physical downlink shared channel (PDSCH) 1 by using downlink control information (DCI) carried in a physical downlink control channel (PDCCH) 1, and a TRP 2 may schedule transmission of a PDSCH 2 by using DCI carried in a PDCCH 2.

The applicant believes that in evolution of subsequent protocols, each TRP may schedule transmission of its PUSCH. Still referring to FIG. 5, that is, the TRP 1 may schedule transmission of a PUSCH 1 by using the DCI carried in the PDCCH 1, and the TRP 2 may schedule transmission of a PUSCH 2 by using the DCI carried in the PDCCH 2.

It should be noted that in the mDCI-mTRP scenario, a demand for DCI is large, and each TRP performs scheduling independently, thus increasing a number of control resource sets (CORESET) associated with DCI. In some implementations, CORESETs may be grouped based on corresponding RRC parameters “control resource set pool index (CORESETPoolIndex)”, that is, control resource sets whose CORESETPoolIndex is “0” may be classified into one group corresponding to the TRP 1, and control resource sets whose CORESETPoolIndex is “1” may be classified into one group corresponding to the TRP 2. In addition, when a network device does not configure CORESETPoolIndex for a control resource set, CORESETPoolIndex may be “0” by default.

In addition, if a terminal device operates in a single TRP (sTRP) mode, a reference point of timing advance for the terminal device is a time point for downlink reception. In an mTRP scenario, the terminal device may still use one of the two TRPs as a reference point for downlink reception to adjust a TA. For example, a TRP whose CORESETPoolIndex is 0 is used as the reference point for downlink reception, or a specific TRP that may be configured by the network device is used as the reference point for downlink reception. In this case, a premise based on a single downlink reference point may be that the terminal device has only one set of downlink receive timelines, that is, depending on a capability of the terminal device.

Certainly, for a terminal device with a relatively strong capability, two different reference points for downlink reception may also be used. Still referring to FIG. 5, the two TRPs may correspond to different downlink reference points. In this case, two TA values indicated by the network device are adjusted based on respective reference points.

### Uplink Multi-TRP Operation

In an existing communications protocol (for example, 3GPP Rel.17), multi-TRP based uplink PUCCH/PUSCH retransmission (repetition) is supported, with the aim of enhancing uplink coverage and transmission reliability. A terminal device needs to send, to different TRPs, physical uplink control channels (PUCCH)/physical uplink shared channels (PUSCH) that carry same content. For PUSCH retransmission, only sDCI-based PUSCH retransmission is supported in an existing standard, in which one timing advance TA is used to sequentially send PUSCHs to different TRPs. For mDCI-based PUSCH retransmission, because there may not be enough ideal backhauls (backhaul) between a plurality of TRPs as connections, independent scheduling by the plurality of TRPs on the terminal device may cause overlapping of different PUSCHs/PUCCHs in terms of time.

For sDCI-based mPUSCH transmission, a sounding reference signal resource set indicator field may be used in uplink scheduling DCI, and one or two SRS resource sets are indicated by using the SRS resource set indicator field. The SRS resource sets point to transmission of one or two TRPs, and sTRP or mTRP uplink transmission may be dynamically adjusted.

Currently, a first TRP and a second TRP may be separately denoted by using a first SRS resource set (1st SRS resource set) and a second SRS resource set (2nd SRS resource set). Therefore, in embodiments of this application, a TRP identity may also be determined based on an identity of an SRS resource set. For example, a TRP identity may be an identity of an SRS resource set.

In addition, for timing advances of an uplink channel and an uplink signal, a same TA value may be used for a PUSCH/PUCCH/SRS (transmitted toward one TRP or directed at two TRPs).

As described above, in a conventional manner, timing advance adjustment is performed on a TA by using a TAG as a granularity, and one TAG corresponds to one serving cell. This manner of configuring a TA by using a serving cell as a granularity may be too coarse, and consequently interference may still exist when a terminal device communicates with a TRP based on a TA corresponding to a serving cell to which the TRP belongs.

For example, if one serving cell includes a plurality of TRPs, there may be different distances between different TRPs and the terminal device. In this case, if the terminal device still sends uplink signals to the plurality of TRPs within the serving cell based on a TA corresponding to the serving cell, interference may still exist when the uplink signals arrive at the TRPs.

Therefore, to avoid the foregoing problem, an embodiment of this application provides a TA configuration manner in which a TRP is used as a granularity. Therefore, different TRPs may have respective TAs, thereby reducing interference caused when a terminal device communicates with a TRP. However, in this TA configuration manner in which a TRP is used as a granularity, after a TA of a TRP (hereinafter referred to as a “first TRP”) in a serving cell fails, behavior of the terminal device is not regulated. As a result, the terminal device and a network device may have different understandings and cannot communicate with each other normally.

Therefore, to avoid the foregoing problem, an embodiment of this application provides a communication method, which helps regulate the behavior of the terminal device, so as to improve a success rate of communication between the terminal device and the network device. The communication method in embodiments of this application is described below with reference to FIG. 6. The communication method shown in FIG. 6 includes step S610.

Step S610: In a case that a TA of a first TRP is invalid, a terminal device or a network device performs an operation 1 and/or an operation 2.

As described above, in some implementations, the TA of the first TRP may be maintained by a TA timer. Therefore, that a TA of a first TRP is invalid may be understood as that the TA timer corresponding to the TA of the first TRP expires.

It should be noted that the TA maintained by the TA timer is configured by using a TRP as a granularity. In some implementations, the TA timer may be a timer (denoted by “timeAlignmentTimer”) associated with the TAG described above. In this case, a TAG may be associated with one or more TRPs. Alternatively, in the foregoing case, a TA with a TRP as a granularity is indicated by a TAG. In this way, it can be learned a TA of which TRP is maintained by the TA timer. Certainly, in this embodiment of this application, the TA timer may be alternatively a new timer. This is not limited in this embodiment of this application.

The foregoing operation 1 may include restoring the TA of the first TRP. Correspondingly, if the TA of the first TRP is restored to a valid TA, the terminal device may communicate with the first TRP based on the valid TA. Alternatively, the terminal device may send uplink data to the first TRP based on the valid TA.

As described above, validity of the TA of the first TRP may be maintained by a TA timer. Therefore, the restoring the TA of the first TRP may include restarting or starting the TA timer for maintaining the TA of the first TRP.

In some implementations, the terminal device may start or restart the TA timer based on first information, where the first information is used to indicate the TA of the first TRP. After the TA timer is started or restarted, the TA of the first TRP and maintained by the TA timer is valid. The first information may be, for example, carried in a MAC protocol data unit (PDU) (for example, a MAC CE or a MAC RAR) or DCI.

It should be noted that, that the terminal device starts or restarts the TA timer based on first information may include: the terminal device starts or restarts the TA timer when receiving the first information. Alternatively, that the terminal device receives the first information may be used as a trigger condition for starting or restarting the TA timer. Correspondingly, after receiving the first information, the terminal device may use a TA indicated in the first information as the TA of the first TRP.

The foregoing operation 2 may include communicating with a second TRP based on a TA of the second TRP. For example, the terminal device may send first uplink data by using an uplink resource of the second TRP. For another example, the terminal device may receive downlink data sent by the second TRP.

The second TRP may belong to a same serving cell as the first TRP, and the TA of the second TRP is valid. In some implementations, that the TA of the second TRP is valid may be understood as that a TA timer corresponding to the TA of the second TRP does not expire.

In this embodiment of this application, in a case that the TA of the first TRP is invalid, it is specified that the terminal device may perform the foregoing operation 1 and/or operation 2, thereby improving a success rate of communication between the terminal device and a network device.

It should be noted that when the terminal device performs the foregoing operation 1 and/or operation 2, correspondingly, the network device also performs the foregoing operation 1 and/or operation 2. The network device may be the second TRP or the first TRP.

The following separately describes the communication method in embodiments of this application with reference to Embodiment 1 and Embodiment 2 by using an example in which the terminal device performs the operation 1 or the operation 2.

### Embodiment 1: The Terminal Device Performs the Operation 1

In some implementations, the terminal device may restore the TA of the first TRP by using a random access procedure. The random access procedure may be triggered by the network device, or may be triggered by the terminal device. The following separately uses two random access procedures as examples to describe the method for restoring the TA of the first TRP in this embodiment of this application.

A random access procedure triggered by the network device is used as an example. Because maintenance of the TA timer by the network device and the terminal device is synchronous, the TA timer for maintaining the TA of the first TRP in the network device also expires after the TA timer for maintaining the TA of the first TRP in the terminal device expires. In this case, the network device may trigger the random access procedure to restore the TA timer for maintaining the TA of the first TRP.

In some implementations, the network device may trigger the random access procedure by sending a PDCCH command to the terminal device. When triggering the random access procedure, the network device may further instruct the terminal device to initiate a random access procedure for the first TRP.

The network device instructs, in many manners, the terminal device to initiate the random access procedure for the first TRP. This is not limited in this embodiment of this application. In some implementations, the network device may instruct, in an implicit manner, the terminal device to initiate the random access procedure for the first TRP. For example, when different resources used for the random access procedure correspond to different TRPs, the network device may indicate, to the terminal device, a resource corresponding to the first TRP and used to initiate the random access procedure, to instruct the terminal device to initiate the random access procedure for the first TRP.

In some other implementations, the network device may instruct, in an explicit manner, the terminal device to initiate the random access procedure for the first TRP. For example, the network device may instruct, by using resource indication information of a resource for the random access procedure, the terminal device to initiate the random access procedure for the first TRP, where the resource indication information may carry indication information of the first TRP. For example, in a case that the network device triggers the random access procedure, the network device may send a trigger indication to the terminal device to trigger the random access procedure of the terminal device, where the trigger indication may carry the resource instruction information and indicate the first TRP.

The indication information of the first TRP may be an identity of the first TRP, and the identity of the first TRP may be, for example, “CORSETPollIndex”. Certainly, in this embodiment of this application, a TRP may be identified by using other information, for example, a reference signal set (for example, an SRS resource set) or a TRP index. This is not limited in this embodiment of this application.

It should be noted that the foregoing resource used for random access may be a resource used for transmitting a message 1 (msg1, or referred to as a “preamble”) in a 4-step random access procedure. Certainly, the foregoing resource used for random access may be alternatively a resource used for transmitting a message A (msgA) in a 2-step random access procedure. The resource may be one or more of a time domain resource, a frequency domain resource, or a code domain resource. For example, different TRPs may be distinguished by using preambles, or different TRPs may be distinguished by using different random access channel occasions (RO).

In this embodiment of this application, after the TA of the first TRP fails, the network device may directly trigger the random access procedure. Certainly, after the TA of the first TRP fails, the network device may alternatively trigger the random access procedure in a case that a first condition is met. The first condition includes one or more of the following: the network device has to-be-sent downlink information; or the network device expects to communicate with the terminal device by using the first TRP. That the network device expects to communicate with the terminal device by using the first TRP may include: the network device expects to receive, by using the first TRP, uplink data sent by the terminal device.

A random access procedure triggered by the terminal device is used as an example. After the TA timer for maintaining the TA of the first TRP in the terminal device expires, the terminal device may trigger the random access procedure to restore the TA timer for maintaining the TA of the first TRP.

In a process in which the terminal device triggers random access, the network device may be notified that the random access procedure is initiated for the first TRP. There are many notification manners, which are not limited in this embodiment of this application. For example, when different resources used for the random access procedure correspond to different TRPs, the terminal device may initiate the random access procedure by using a resource corresponding to the first TRP and used to initiate the random access procedure. Correspondingly, the network device may determine, based on the resource used by the terminal device to initiate the random access procedure, that the random access procedure is triggered by the terminal device for the first TRP.

It should be noted that the foregoing resource used for random access may be a resource used for transmitting a message 1 (msg1, or referred to as a “preamble”) in a 4-step random access procedure. Certainly, the foregoing resource used for random access may be alternatively a resource used for transmitting a message A (msgA) in a 2-step random access procedure. The resource may be one or more of a time domain resource, a frequency domain resource, or a code domain resource. For example, different TRPs may be distinguished by using preambles, or different TRPs may be distinguished by using different random access channel occasions (RO).

In this embodiment of this application, after the TA of the first TRP fails, the terminal device may directly trigger the random access procedure. Certainly, after the TA of the first TRP fails, the terminal device may alternatively trigger the random access procedure in a case that a second condition is met. The second condition may include: second uplink data arrives at the terminal device. Alternatively, the second condition includes: the second uplink data arrives and the terminal device is in an uplink out-of-synchronization state.

In some implementations, the second uplink data includes one or more of the following: a logical channel or a data radio bearer (DRB) for transmitting the second uplink data is associated with the first TRP; to-be-transmitted data in a packet data convergence protocol (PDCP) layer and/or a radio link control (RLC) layer; to-be-transmitted data in a hybrid automatic repeat request (HARQ) buffer; data associated with an SR or a buffer status report (BSR); or a to-be-transmitted PUCCH.

The to-be-transmitted data in the PDCP layer and/or the RLC layer may include at least one of the following: a PDCP protocol data unit (PDU), a PDCP SDU, a RLC PDU, or a RLC SDU. A PDU may include, for example, a control PDU, and an SDU may include, for example, a control SDU.

The to-be-transmitted PUCCH may include, for example, a scheduling request (SR), a HARQ feedback, and channel state information (CSI).

The to-be-transmitted data in the HARQ buffer may include, for example, to-be-newly transmitted data or to-be-retransmitted data.

The foregoing describes the method for restoring the TA of the first TRP, and the following describes a condition (also referred to as a “third condition”) for restoring the TA of the first TRP in this embodiment of this application. It should be noted that in this embodiment of this application, after the TA of the first TRP fails, the operation of restoring the TA of the first TRP may be directly performed. Certainly, the operation of restoring the TA of the first TRP may alternatively be performed in a case that the third condition is met.

In some implementations, the third condition may include one or more of the following: the network device schedules an uplink resource of the first TRP for the terminal device; the serving cell supports (or is configured with) retransmission; or TAs of all TRPs within the serving cell are invalid.

If the third condition includes that the network device schedules the uplink resource of the first TRP for the terminal device, the terminal device may perform the operation of restoring the TA of the first TRP, so as to send uplink data (for example, a PUSCH) to the network device by using the uplink resource of the first TRP. In other words, if the terminal device cannot currently determine a TRP to which to-be-transmitted data is to be sent, the terminal device may wait for scheduling information (for example, downlink control information (DCI)) of the network device. If the scheduling information is scheduling the uplink resource of the first TRP for the terminal device, the terminal device may first restore the TA of the first TRP, and then perform uplink transmission based on the uplink resource indicated by the scheduling information.

It should be noted that the scheduling information may be requested by the terminal device by using an SR. Certainly, the scheduling information may alternatively be sent by the network device independently. This is not limited in this embodiment of this application. If the scheduling information is requested by sending an SR by the terminal device, a resource (for example, a PUCCH resource) for the SR sent by the terminal device may be associated with a TRP, and different TRPs may be associated with different resources. In other words, when the terminal device sends the SR by using a resource corresponding to the first TRP, the network device may determine, based on the resource used by the SR, that the uplink resource requested by the terminal device is the uplink resource of the first TRP. Correspondingly, the network device may schedule the uplink resource of the first TRP for the terminal device.

For example, in a serving cell, an SR of a TRP 1 may be associated with a PUCCH resource of a TRP 2. If a TA of the TRP 1 is invalid, the terminal device may trigger an SR. Because the SR is associated with the PUCCH resource of the TRP 2 whose TA is valid, after receiving the SR, the network device may learn that the TRP 1 has a transmission requirement, and the TA of the TRP 1 needs to be restored.

As described above, retransmission in a serving cell means that same data needs to be transmitted by using a plurality of TRPs. Therefore, if the serving cell is configured with retransmission, it means that same data needs to be transmitted by using a plurality of TRPs. In this case, the TA of the first TRP may be restored, so that retransmission can be subsequently performed by using the first TRP and another TRP (for example, the second TRP).

In some implementations, that the serving cell supports retransmission may be determined based on one or more of the following: the serving cell is configured with PUCCH/PUSCH retransmission; PUCCH transmission of the serving cell is associated with a plurality of pieces of spatial relation information (spatial relation info); an SRS of the serving cell is associated with a plurality of resource sets; or PDCCH transmission or PDSCH transmission of the serving cell is associated with a plurality of transmission configuration indication states (TCI state).

Based on the foregoing descriptions of the uplink multi-TRP operation, when the SRS of the serving cell is associated with a plurality of resource sets, it may indicate that the serving cell supports uplink PUCCH/PUSCH retransmission.

In some scenarios, PDCCH transmission or PDSCH transmission of the serving cell is associated with a plurality of TCI states, and/or PUCCH transmission of the serving cell is associated with a plurality of pieces of spatial relation information. This association manner usually exists in the serving cell that supports retransmission. Therefore, it may be determined, based on the foregoing association manner, that the serving cell supports retransmission.

If the third condition includes that TAs of all TRPs within the serving cell are invalid, the terminal device may select to restore a TA of a specified TRP (for example, the TA of the first TRP) in the serving cell.

In some implementations, if the TAs of all the TRPs within the serving cell are invalid, the terminal device may notify the network device. For example, the terminal device may add indication information to a message 3 (msg3) in a 4-step random access procedure, to indicate that the TAs of all the TRPs within the serving cell are invalid. For another example, the terminal device may add indication information to a message A (msgA) in a 2-step random access procedure, to indicate that the TAs of all the TRPs within the serving cell are invalid.

### Embodiment 2: The Terminal Device Performs the Operation 2

If the TA of the first TRP is invalid and the TA of the second TRP is valid, the terminal device may directly communicate with the second TRP, thereby reducing a delay required for receiving or sending data by the terminal device.

As described above, in some scenarios, the terminal device may send the first uplink data based on the TA of the second TRP and by using the uplink resource of the second TRP. The uplink resource of the second TRP may be configured by the network device for the terminal device by using a configured grant (CG). Certainly, the uplink resource of the second TRP may alternatively be dynamically scheduled by the network device for the terminal device by using a dynamic grant (DG).

In an example in which the uplink resource of the second TRP includes a resource configured based on a CG, if the uplink resource of the second TRP is an uplink resource configured by using a configured grant type 1, the terminal device may directly use the uplink resource of this type to transmit the first uplink data. In some implementations, the uplink resource of the configured grant type 1 may be configured by RRC by using higher layer signaling (for example, IE ConfiguredGrantConfig). This is not limited in this embodiment of this application.

If the uplink resource of the second TRP is an uplink resource configured by using a configured grant type 2, in a case that the uplink resource of the second TRP is an activated uplink resource, the terminal device may use the uplink resource of this type to transmit the first uplink data. In some implementations, the uplink resource configured by using the configured grant type 2 may be indicated by DCI for activation and deactivation. In other words, a parameter required by the uplink resource configured by using the configured grant type 2 may be configured by IE ConfiguredGrantConfig, but the configured uplink resource can be used only when being activated by the DCI.

It should be noted that, in some scenarios, there is no activated uplink resource in the uplink resource of the second TRP and configured by using the configured grant type 2. In this case, the terminal device may request, by triggering an SR procedure and/or a BSR procedure, the network device to schedule an uplink resource for transmission. If the terminal device triggers the SR procedure, a resource (for example, a PUCCH resource) for the SR sent by the terminal device may be associated with a TRP, and different TRPs may be associated with different resources. In other words, when the terminal device sends the SR by using a resource associated with the second TRP, the network device may determine, based on the resource used by the SR, that the uplink resource requested by the terminal device is the uplink resource of the second TRP. Correspondingly, the network device may schedule the uplink resource of the second TRP for the terminal device.

In some scenarios, the SR may be further used to indicate to the network device that the TA of the first TRP needs to be restored. In other words, the SR may be used to indicate that the TA of the first TRP is invalid and there is to-be-transmitted data. For example, the SR of the first TRP may be associated with a PUCCH resource of the second TRP. If the TA of the first TRP is invalid, the terminal device may trigger the SR. Because the SR is associated with the PUCCH resource of the second TRP whose TA is valid, after receiving the SR, the network device may learn that the first TRP has a transmission requirement and the TA of the first TRP needs to be restored.

On the contrary, if a resource (for example, a PUCCH resource) of the SR sent by the terminal device may not be related to a TRP, when the terminal device has to-be-transmitted uplink data, the terminal device may trigger the SR, and the network device may send scheduling information to the terminal device in response to the SR. Correspondingly, the terminal device may determine, based on the scheduling information sent by the network device, a TRP for performing uplink transmission. Assuming that the network device schedules the uplink resource of the second TRP for the terminal device, the terminal device may perform uplink transmission by using the uplink resource of the second TRP.

It should be noted that, in this embodiment of this application, a condition for triggering the SR may be based on an SR trigger condition specified in a current protocol. Certainly, the condition for triggering the SR may be alternatively a condition introduced in a future protocol. This is not limited in this embodiment of this application.

In an example in which the uplink resource of the second TRP includes a resource configured based on a DG, if the terminal device has the available uplink resource of the second TRP and configured based on the DG, the terminal device may directly use the uplink resource to transmit the first uplink data. In some implementations, the network device may dynamically configure the uplink resource of the second TRP for the terminal device by using DCI. Correspondingly, the terminal device may generate an uplink data packet (for example, a MAC PDU) based on the dynamically configured uplink resource, and deliver the data packet to a lower layer (for example, a physical layer).

For the terminal device, if the second TRP has no available uplink resource (including an uplink resource configured based on a CG and an uplink resource configured based on a DG), the terminal device may request, by triggering an SR procedure and/or a BSR procedure, the network device to schedule an uplink resource for transmission. If the terminal device triggers the SR procedure, a resource (for example, a PUCCH resource) for the SR sent by the terminal device may be associated with a TRP, and different TRPs may be associated with different resources. In other words, when the terminal device sends the SR by using a resource corresponding to the second TRP, the network device may determine, based on the resource used by the SR, that the uplink resource requested by the terminal device is the uplink resource of the second TRP. Correspondingly, the network device may schedule the uplink resource of the second TRP for the terminal device.

In some scenarios, the SR may be further used to indicate to the network device that the TA of the first TRP needs to be restored. In other words, the SR may be used to indicate that the TA of the first TRP is invalid and there is to-be-transmitted data. For example, the SR of the first TRP may be associated with a PUCCH resource of the second TRP. If the TA of the first TRP is invalid, the terminal device may trigger the SR. Because the SR is associated with the PUCCH resource of the second TRP whose TA is valid, after receiving the SR, the network device may learn that the first TRP has a transmission requirement and the TA of the first TRP needs to be restored. Correspondingly, the network device may schedule the uplink resource of the first TRP for the terminal device.

This embodiment of this application further provides an operation (also referred to as a “target operation”) that may be performed by the terminal device after the TA of the first TRP fails and an object for which the operation is performed. The following first describes the operation that may be performed by the terminal device.

In some implementations, after the TA of the first TRP fails, a target operation is triggered. The target operation includes one or more of the following operations: flushing a hybrid automatic repeat request (HARQ) buffer; notifying radio resource control (RRC) to release an uplink resource (the uplink resource may include, for example, a PUCCH, an SRS, a cell group (CG), a PUSCH, and semi-persistent scheduling (SPS)); maintaining a timing advance absolute value; initiating a random access procedure; or retransmitting data in the HARQ buffer by using a TRP whose TA is valid. Certainly, in some other implementations, after the TA of the first TRP fails, the terminal device may not perform the foregoing target operation.

In some scenarios (for example, a serving cell is configured with mTRP), when the TA of the first TRP fails, a TA of another TRP in the serving cell may be valid. Therefore, the data in the HARQ buffer may be retransmitted by using the TRP whose TA is valid. In this way, the terminal device may not perform any target operation.

It should be noted that the target operation may further include one or more operations specified in an existing protocol. For example, the target operation may include one or more of the following operations: clearing a configured downlink assignment and an uplink grant; clearing a PUSCH resource for semi-persistent CSI reporting; or considering all running TA timers as expired.

In different scenarios, the target operation may be performed for different objects. In some implementations, if a TAG may be associated with TAs of one or more TRPs in the TAG-based TA indication manner, the target operation is performed for one or more of the following objects: all serving cells of the terminal device; a TRP associated with each of one or more TAGS; or a serving cell in which the TRP associated with each of the one or more TAGS is located.

All the serving cells of the terminal device may be all serving cells to which the terminal device establishes a connection, or may include all serving cells in a serving cell list of the terminal device, or may include all serving cells that communicate with the terminal device. This is not limited in this embodiment of this application.

If the object for which the target operation is performed includes the TRP associated with each of the one or more TAGS, the target operation may include flushing a HARQ buffer (buffer) associated with the TRP included in each of the one or more TAGs. For example, for a serving cell configured with a plurality of TRPs, each TRP in the serving cell may have one HARQ entity, and a HARQ procedure in each HARQ entity may belong to a different TRP. In this case, the target operation may include flushing a HARQ buffer corresponding to a HARQ procedure associated with the TRP included in each of the one or more TAGS.

For another example, for a serving cell configured with a plurality of TRPs, each serving cell may have one HARQ entity, and a HARQ procedure in the HARQ entity may be divided into a plurality of groups, where the plurality of groups are associated with a plurality of TRPs. In this case, the target operation may include flushing a HARQ buffer corresponding to a HARQ procedure in a group associated with the TRP included in each of the one or more TAGs.

If the object for which the target operation is performed includes the TRP associated with each of the one or more TAGS, the target operation includes notifying RRC to release an uplink resource. Generally, for a serving cell configured with a plurality of TRPs, each TRP in the serving cell may be configured with a corresponding uplink resource. Therefore, the target operation may include notifying the RRC to release an uplink resource corresponding to the TRP associated with each of the one or more TAGS.

It should be noted that the foregoing TAG may be a PTAG or an STAG. This is not limited in this embodiment of this application.

In some other implementations, when the network device directly indicates a TA of a TRP, the target operation is performed for one or more of the following objects: all serving cells of the terminal device; the TRP; or a serving cell in which the TRP is located.

When the object for which the target operation is performed includes a TRP, the target operation may include flushing a HARQ buffer associated with the TRP. For example, for a serving cell configured with a plurality of TRPs, each TRP in the serving cell may have one HARQ entity, and a HARQ procedure in each HARQ entity may belong to a different TRP. In this case, the target operation may include flushing a HARQ buffer corresponding to a HARQ procedure associated with the foregoing TRP.

For another example, for a serving cell configured with a plurality of TRPs, each serving cell may have one HARQ entity, and a HARQ procedure in the HARQ entity may be divided into a plurality of groups, where the plurality of groups are associated with a plurality of TRPs. In this case, the target operation may include flushing a HARQ buffer corresponding to a HARQ procedure in a group associated with the TRP.

If the object for which the target operation is performed includes a TRP, the target operation includes notifying RRC to release an uplink resource. Generally, for a serving cell configured with a plurality of TRPs, each TRP in the serving cell may be configured with a corresponding uplink resource. Therefore, the target operation may include notifying the RRC to release an uplink resource corresponding to the TRP.

It should be noted that the foregoing TAG may be a PTAG or an STAG. This is not limited in this embodiment of this application.

It may be learned from the foregoing target operation that, in some cases, after the TA of the first TRP fails, the terminal device may not perform any target operation (for example, releasing the uplink resource of the first TRP). In this case, because a timer for maintaining the validity of the TA of the first TRP is generally maintained at a MAC layer, a lower layer (for example, a physical layer) may not learn that the TA of the first TRP fails, and therefore may continue to send uplink data to the first TRP, resulting in a communication failure.

Therefore, to avoid the foregoing problem, in a case that the TA of the first TRP is invalid, the MAC layer of the terminal device may send first indication information to the lower layer, where the first indication information is used to indicate that the TA of the first TRP is invalid. That is, in a case that the TA of the first TRP is invalid and the uplink resource of the first TRP is not released, the MAC layer sends the first indication information to the lower layer of the MAC layer. Correspondingly, after the TA of the first TRP is restored to be valid, the MAC layer may send second indication information to the lower layer, where the second indication information is used to indicate that the TA of the first TRP is valid.

In some other cases, after the TA of the first TRP fails, if the terminal device performs the target operation (for example, releasing the uplink resource of the first TRP), even if the lower layer does not known that the TA of the first TRP is invalid, the lower layer does not send uplink data to the first TRP because the uplink resource of the first TRP is released. Therefore, to reduce a resource occupied for transmitting the first indication information, the MAC layer may not transmit the first indication information. Certainly, in this embodiment of this application, the MAC layer may send the first indication information regardless of whether the terminal device performs the target operation. This is not limited in this embodiment of this application.

In embodiments of this application, a TA is configured by using a TRP as a granularity. After the TA of the first TRP in the serving cell fails, the terminal device may communicate with the second TRP based on the TA of the second TRP in the serving cell; and/or restore the TA of the first TRP to be valid, so as to ensure that the terminal device and the serving cell can continue to communicate with each other.

The method embodiments of this application are described in detail above with reference to FIG. 1 to FIG. 6. Apparatus embodiments of this application are described below in detail with reference to FIG. 7 to FIG. 9. It should be understood that the descriptions of the method embodiments correspond to the descriptions of the apparatus embodiments, and therefore, for a part that is not described in detail, reference may be made to the foregoing method embodiments.

FIG. 7 is a schematic diagram of a terminal device according to an embodiment of this application. The terminal device shown in FIG. 7 includes a processing unit 710.

The processing unit 710 is configured to: in a case that a timing advance TA of a first transmitting and receiving point TRP is invalid, perform one or more of the following operations: communicating with a second TRP based on a TA of the second TRP; or restoring the TA of the first TRP to be valid, where the TA of the second TRP is valid, and the first TRP and the second TRP belong to one serving cell of the terminal device.

In a possible implementation, the restoring the TA of the first TRP to be valid includes: restoring, by using a random access procedure, the TA of the first TRP to be valid.

In a possible implementation, the random access procedure is triggered by a network device or the terminal device.

In a possible implementation, in a case that a first condition is met, the random access procedure is triggered by the network device, where the first condition includes one or more of the following: the network device has to-be-sent downlink information; or the network device expects to communicate with the terminal device by using the first TRP.

In a possible implementation, in a case that a second condition is met, the random access procedure is triggered by the terminal device, where the second condition includes: second uplink data arrives at the terminal device.

In a possible implementation, the second uplink data includes one or more of the following: a logical channel or a data radio bearer DRB for transmitting the second uplink data is associated with the first TRP; to-be-transmitted data in a packet data convergence protocol PDCP layer and/or a radio link control RLC layer; to-be-transmitted data in a hybrid automatic repeat request HARQ buffer; data associated with a scheduling request SR or a buffer status report BSR; or a to-be-transmitted physical uplink control channel PUCCH.

In a possible implementation, in a case that the TA of the first TRP is invalid and a third condition is met, the terminal device restores the TA of the first TRP, where the third condition includes one or more of the following: the network device schedules an uplink resource of the first TRP for the terminal device; the serving cell supports retransmission; or TAs of all TRPs within the serving cell are invalid.

In a possible implementation, that the serving cell supports retransmission includes one or more of the following: the serving cell is configured with physical uplink shared channel PUSCH retransmission; PUCCH transmission of the serving cell is associated with a plurality of pieces of spatial relation information; a sounding reference signal SRS of the serving cell is associated with a plurality of resource sets; or PDCCH transmission or PDSCH transmission of the serving cell is associated with a plurality of transmission configuration indication TCI states.

In a possible implementation, the communicating with a second TRP based on a TA of the second TRP includes: sending first uplink data to the second TRP based on the TA of the second TRP, where an uplink resource of the second TRP and for transmitting the first uplink data includes one or more of the following: an uplink resource configured by using a configured grant type 1 of a configured grant; an activated uplink resource in an uplink resource configured by using a configured grant type 2 of a configured grant; an uplink resource scheduled based on a dynamic grant; or an uplink resource requested by using an SR, where an SR resource used by the SR is associated with the second TRP.

In a possible implementation, in a case that the TA of the first TRP is invalid, the terminal device further includes: a sending unit, configured to send first indication information to a lower layer of a media access control MAC layer by using the MAC, where the first indication information is used to indicate that the TA of the first TRP is invalid.

In a possible implementation, the sending unit is further configured to: in a case that the TA of the first TRP is invalid and an uplink resource of the first TRP is not released, send the first indication information to the lower layer of the MAC layer by using the MAC layer.

FIG. 8 is a schematic diagram of a network device according to an embodiment of this application. The network device 800 shown in FIG. 8 includes a processing unit 810.

The processing unit 810 is configured to: in a case that a timing advance TA of a first transmitting and receiving point TRP is invalid, perform one or more of the following operations: communicating with a terminal device based on a TA of a second TRP; or restoring the TA of the first TRP to be valid, where the TA of the second TRP is valid, and the first TRP and the second TRP belong to one serving cell of the terminal device.

In a possible implementation, that the network device restores the TA of the first TRP to be valid includes: the network device restores, by using a random access procedure, the TA of the first TRP to be valid.

In a possible implementation, the random access procedure is triggered by the network device or the terminal device.

In a possible implementation, in a case that a first condition is met, the random access procedure is triggered by the network device, where the first condition includes one or more of the following: the network device has to-be-sent downlink information; or the network device expects to communicate with the terminal device by using the first TRP.

In a possible implementation, in a case that a second condition is met, the random access procedure is triggered by the terminal device, where the second condition includes: second uplink data arrives at the terminal device.

In a possible implementation, the second uplink data includes one or more of the following: a logical channel or a data radio bearer DRB for transmitting the second uplink data is associated with the first TRP; to-be-transmitted data in a packet data convergence protocol PDCP layer and/or a RLC layer; to-be-transmitted data in a hybrid automatic repeat request HARQ buffer; data associated with a scheduling request SR or a buffer status report BSR; or a to-be-transmitted physical uplink control channel PUCCH.

In a possible implementation, in a case that the TA of the first TRP is invalid and a third condition is met, the network device restores the TA of the first TRP, where the third condition includes one or more of the following: the network device schedules an uplink resource of the first TRP for the terminal device; the serving cell supports retransmission; or TAs of all TRPs within the serving cell are invalid.

In a possible implementation, that the serving cell supports retransmission includes one or more of the following: the serving cell is configured with physical uplink shared channel PUSCH retransmission; PUCCH transmission of the serving cell is associated with a plurality of pieces of spatial relation information; a sounding reference signal SRS of the serving cell is associated with a plurality of resource sets; or PDCCH transmission or PDSCH transmission of the serving cell is associated with a plurality of transmission configuration indication TCI states.

In a possible implementation, the communicating with a terminal device based on a TA of a second TRP includes: receiving, based on the TA of the second TRP, first uplink data sent by the terminal device, where an uplink resource of the second TRP and for transmitting the first uplink data includes one or more of the following: an uplink resource configured by using a configured grant type 1 of a configured grant; an activated uplink resource in an uplink resource configured by using a configured grant type 2 of a configured grant; an uplink resource scheduled based on a dynamic grant; or an uplink resource requested by using an SR, where an SR resource used by the SR is associated with the second TRP.

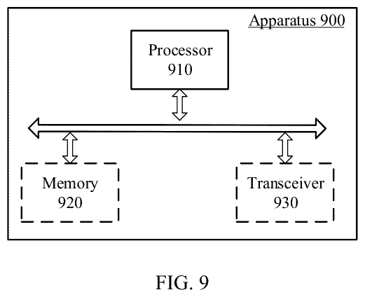

In an optional embodiment, the processing unit 710 may be a processor 910. The terminal device 700 may further include a transceiver 930 and a memory 920, which are specifically shown in FIG. 9.

In an optional embodiment, the processing unit 810 may be a processor 910. The network device 800 may further include a transceiver 930 and a memory 920, which are specifically shown in FIG. 9.

FIG. 9 is a schematic structural diagram of a communications apparatus according to an embodiment of this application. Dashed lines in FIG. 9 indicate that the unit or module is optional. The apparatus 900 may be configured to implement a method described in the foregoing method embodiments. The apparatus 900 may be a chip, a terminal device, or a network device.

The apparatus 900 may include one or more processors 910. The processor 910 may allow the apparatus 900 to implement a method described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array FPGA) or another programmable logic device, a discrete gate or transistor logic device, a discrete hardware component, or the like. A general-purpose processor may be a microprocessor, or the processor may also be any conventional processor or the like.

The apparatus 900 may further include one or more memories 920. The memory 920 stores a program. The program may be executed by the processor 910, to cause the processor 910 to perform a method described in the foregoing method embodiments. The memory 920 may be separately from the processor 910 or may be integrated into the processor 910.

The apparatus 900 may further include a transceiver 930. The processor 910 may communicate with another device or chip by using the transceiver 930. For example, the processor 910 may transmit data to and receive data from another device or chip through the transceiver 930.

An embodiment of this application further provides a computer-readable storage medium, configured to store a program. The computer-readable storage medium may be applied to a terminal or a network device provided in embodiments of this application, and the program causes a computer to perform the methods to be performed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In the embodiments of this application, “indicate” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should also be understood that, determining B based on A does not mean determining B based only on A, but instead B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, the “predefining” may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual needs to achieve the objectives of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising a processor and a memory, wherein the memory is configured to store a computer program, and the processor is configured to execute the computer program stored in the memory to cause the terminal device to perform a method of:
in a case that a timing advance (TA) of a first transmitting and receiving point (TRP) is invalid, performing one or more of following operations:
communicating with a second TRP based on a TA of the second TRP; or
restoring the TA of the first TRP to be valid,
wherein the TA of the second TRP is valid, and the first TRP and the second TRP belong to one serving cell of the terminal device.

2. The terminal device according to claim 1, wherein the restoring the TA of the first TRP to be valid comprises: restoring, by using a random access procedure, the TA of the first TRP to be valid.

3. The terminal device according to claim 2, wherein the random access procedure is triggered by the terminal device.

4. The terminal device according to claim 1, wherein the processor is further configured to execute the computer program stored in the memory to cause the terminal device to perform a method of:
after the TA of the first transmitting and TRP fails, performing one or more of following operations:
flushing a hybrid automatic repeat request (HARQ) buffer;
notifying radio resource control (RRC) to release an uplink resource;
maintaining a timing advance absolute value;
initiating a random access procedure; or
retransmitting data in a HARQ buffer by using a TRP whose TA is valid.

5. The terminal device according to claim 3, wherein in a case that a second condition is met, the random access procedure is triggered by the terminal device, wherein the second condition comprises: second uplink data arrives at the terminal device.

6. The terminal device according to claim 5, wherein the second uplink data comprises one or more of following:
a logical channel or a data radio bearer (DRB) for transmitting the second uplink data is associated with the first TRP;
to-be-transmitted data in a packet data convergence protocol (PDCP) layer and/or a radio link control (RLC) layer;
to-be-transmitted data in HARQ buffer;
data associated with a scheduling request (SR) or a buffer status report (BSR); or
a to-be-transmitted physical uplink control channel (PUCCH).

7. The terminal device according to claim 1, wherein in a case that the TA of the first TRP is invalid and a third condition is met, the terminal device restores the TA of the first TRP, wherein the third condition comprises one or more of following:
the network device schedules an uplink resource of the first TRP for the terminal device;
the serving cell supports retransmission; or
TAs of all TRPs within the serving cell are invalid.

8. The terminal device according to claim 7, wherein that the serving cell supports retransmission comprises one or more of following:
the serving cell is configured with physical uplink shared channel (PUSCH) retransmission;
PUCCH transmission of the serving cell is associated with a plurality of pieces of spatial relation information;
a sounding reference signal (SRS) of the serving cell is associated with a plurality of resource sets; or
physical downlink control channel (PDCCH) transmission or physical downlink shared channel (PDSCH) transmission of the serving cell is associated with a plurality of transmission configuration indication TCI states.

9. The terminal device according to claim 1, wherein the communicating with a second TRP based on a TA of the second TRP comprises: sending first uplink data to the second TRP based on the TA of the second TRP,
wherein an uplink resource of the second TRP and for transmitting the first uplink data comprises one or more of following:
an uplink resource configured by using a configured grant type 1 of a configured grant;
an activated uplink resource in an uplink resource configured by using a configured grant type 2 of a configured grant;
an uplink resource scheduled based on a dynamic grant; or
an uplink resource requested by using an SR, wherein an SR resource used by the SR is associated with the second TRP.

10. The terminal device according to claim 1, wherein the processor is further configured to execute the computer program stored in the memory to cause the terminal device to perform a method of:
sending, by a media access control (MAC) layer of the terminal device, first indication information to a lower layer of the MAC layer, wherein the first indication information is used to indicate that the TA of the first TRP is invalid.

11. The terminal device according to claim 10, wherein the sending, by a MAC layer of the terminal device, first indication information to a lower layer of the MAC comprises:
in a case that the TA of the first TRP is invalid and an uplink resource of the first TRP is not released, sending, by the MAC layer, the first indication information to the lower layer of the MAC layer.

12. The terminal device according to claim 4, wherein the uplink resource comprises one or more of following: a PUCCH, an SRS, a cell group (CG), a PUSCH, or semi-persistent scheduling (SPS).

13. A network device, comprising a processor and a memory, wherein the memory is configured to store a computer program, and the processor is configured to execute the computer program stored in the memory to cause the network device to perform a method of:
in a case that a timing advance (TA) of a first transmitting and receiving point (TRP) is invalid, performing one or more of following operations:
communicating with a terminal device based on a TA of a second TRP; or
restoring the TA of the first TRP to be valid,
wherein the TA of the second TRP is valid, and the first TRP and the second TRP belong to one serving cell of the terminal device.

14. The network device according to claim 13, wherein the restoring the TA of the first TRP to be valid comprises: restoring, by using a random access procedure, the TA of the first TRP to be valid.

15. The network device according to claim 14, wherein the random access procedure is triggered by the network device.

16. The network device according to claim 15, wherein in a case that a first condition is met, the random access procedure is triggered by the network device, wherein the first condition comprises one or more of following:
the network device has to-be-sent downlink information; or
the network device expects to communicate with the terminal device by using the first TRP.

17. The network device according to claim 15, wherein the random access procedure is triggered by the network device sending a (PDCCH) command to the terminal device.

18. The network device according to claim 15, wherein the processor is further configured to execute the computer program stored in the memory to cause the network device to perform a method of:
instructing the terminal device to initiate a random access procedure for the first TRP.

19. The network device according to claim 18, wherein the instructing the terminal device to initiate a random access procedure for the first TRP comprises: instructing, in an explicit manner, the terminal device to initiate a random access procedure for the first TRP, and the explicit manner comprises one or more of following:
instructing by using resource indication information of a resource for the random access procedure, the terminal device to initiate the random access procedure for the first TRP, wherein indication information of the first TRP is carried in the resource indication information; or
instructing, by using a trigger indication sent by the network, the terminal device to initiate the random access procedure for the first TRP, resource instruction information is carried in the trigger indication and indicates the first TRP.

20. A communication method, comprising:
in a case that a timing advance (TA) of a first transmitting and receiving point (TRP) is invalid, performing, by a terminal device, one or more of following operations:
communicating with a second TRP based on a TA of the second TRP; or
restoring the TA of the first TRP to be valid,
wherein the TA of the second TRP is valid, and the first TRP and the second TRP belong to one serving cell of the terminal device.
